(19) United States
(12) Patent Application Publication
(10) Pub. No.: US 2004/0165137 A1
(43) Pub. Date: Aug. 26, 2004

(54) Liquid crystal module

(76) Inventor: Ming-Szu Chan, Hsinchu (TW)

Correspondence Address: QUINTERO LAW OFFICE, 1617 BROADWAY, 3RD FLOOR, SANTA MONICA, CA, 90404, US

(21) Appl. No.: 10/770,258

(22) Filed: Feb. 2, 2004

(30) Foreign Application Priority Data
Feb. 25, 2003 (TW) 92202921

(51) Int. Cl. G02F 1/1345

(52) U.S. Cl. 349/151

(57) ABSTRACT

A liquid crystal module. A flexible circuit board has an insulated substrate formed by a plurality of openings, with a plurality of lead wires enclosed by the insulated substrate and exposed by the openings. An LED and a Zener diode are coupled to the lead wires through the openings, such that the size of the flexible circuit board is reduced.

### BACKGROUND OF THE INVENTION

1. Field of the Invention

The present invention relates to a liquid crystal module, and in particular to a liquid crystal module provided with a reduced flexible circuit board for reduced volume.

2. Description of the Related Art

With the dual demands on personal digital assistants (PDA) for larger displays and smaller volume, components such as frame, circuit board, and others must be reduced in size commensurately.

In FIG. 1, a conventional liquid crystal module P has a body 100 and a flexible circuit board 200. The flexible circuit board 200 is provided with two Light-Emitting Diodes (LED) 210, two Zener diodes 220 and a port 250. One LED 210 and one Zener diode 220 are paired and located at two different sites of the flexible circuit board 200.

In FIGS. 2 and 4, the flexible circuit board 200 has a plurality of lead wires 230 and an insulating substrate 240. The lead wires 230 connect all the LEDs 210 and the Zener diodes 220 to the port 250. The insulating substrate 240 is plastic and encloses the lead wires 230.

The layout of LED 210 and Zener diode 220 is shown in FIG. 3. The LED 210 and the Zener diode 220 are coupled to the lead wires 230, and the Zener diode 220 is connected in parallel to the LED 210. Owing to the resistance of the Zener diode 220 being less than that of the LED 210, the large unstable current can be kept from reaching LED 210, thus avoiding burnout.

Joints (not shown) connecting the LED 210 and the Zener diode 220 are preset on the lead wires 230 and exposed to the surroundings, and pins (not shown) of the LED 210 and the Zener diode 220 can be coupled to the joints of the lead wires 230 by welding.

However, the arrangement of the joints and the layout of the LED 210 and the Zener diode 220 on the flexible circuit board 200 are fixed, so that the size of the flexible circuit board 200 cannot be reduced, and thus the volume of the liquid crystal module cannot be reduced.

### SUMMARY OF THE INVENTION

Accordingly, an object of the invention is to provide a reduced flexible circuit board in a liquid crystal module, so that the size of the liquid crystal module can be effectively reduced.

Another object of the invention is to provide a flexible circuit board comprising an insulating substrate formed by a plurality of openings, with a plurality of lead wires enclosed by the insulating substrate and exposed by the openings. An LED and a Zener diode can be coupled to the lead wires through the openings. Thus, the size of the flexible circuit board is reduced.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic view of a conventional liquid crystal module (P);

FIG. 2 is a plane view showing the inner structure of a flexible circuit board of the conventional liquid crystal module (P) in FIG. 1;

FIG. 3 is a plane view of the layout of a Zener diode and a LED in FIG. 2;

FIG. 4 is a cross-section according to line (A-A) in FIG. 2;

FIG. 5 is a plane view of a flexible circuit board (400) according to a first embodiment of the present invention;

FIG. 6 is a cross-section according to line (I-I) in FIG. 5;

FIG. 7 is a plane view of a liquid crystal module (F) provided with the flexible circuit board (400);

FIG. 8 is a plane view of a flexible circuit board (400) according to a second embodiment of the present invention; and

FIG. 9 is a cross-section according to line (II-II) in FIG. 8.

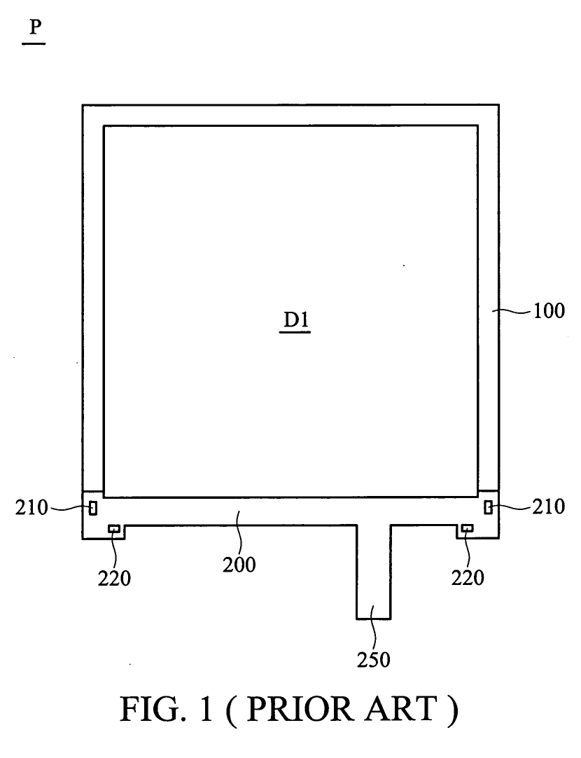

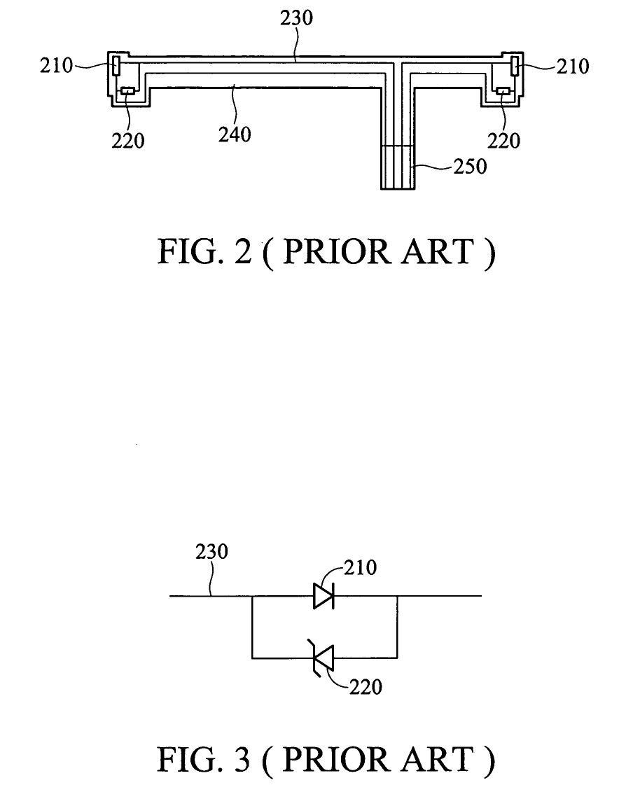

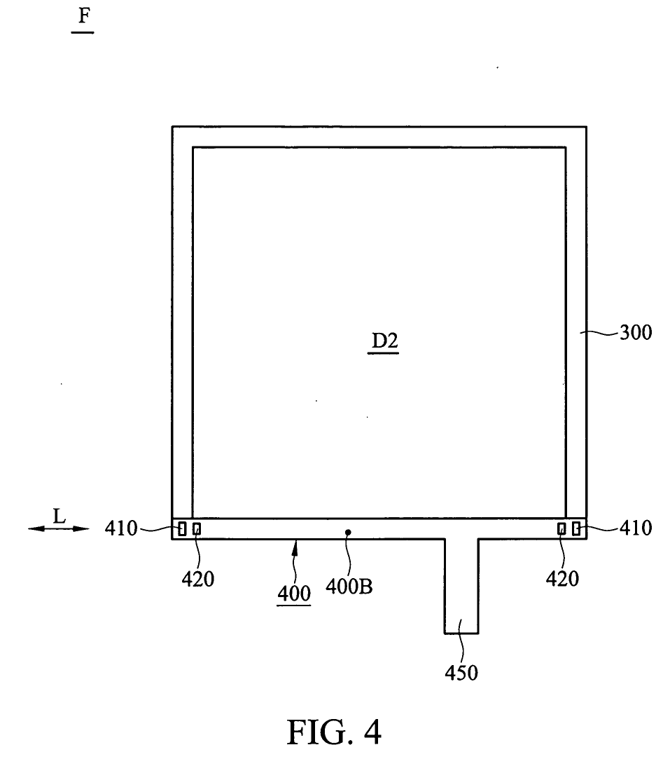

### DETAILED DESCRIPTION OF THE INVENTION

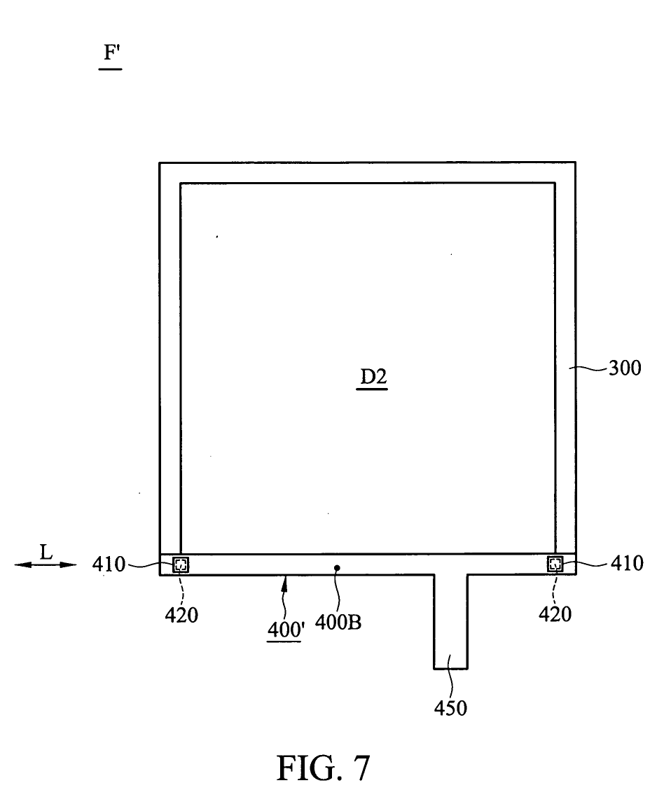

Referring to FIG. 7, in a first embodiment of the invention, a liquid crystal module F comprises a rectangular body 300, a flexible circuit board 400 and a port 450. The flexible circuit board 400 is electrically coupled to the port 450 and disposed on the body 300. The flexible circuit board 400 has two LEDs 410 and two Zener diodes 420, with one LED 410 and one Zener diode 420 paired and located at two different sites of the flexible circuit board 400. In the present invention, the liquid crystal module F can be a liquid-crystal display of a mobile phone or a personal digital assistant (PDA), and the body 300 is made of plastic.

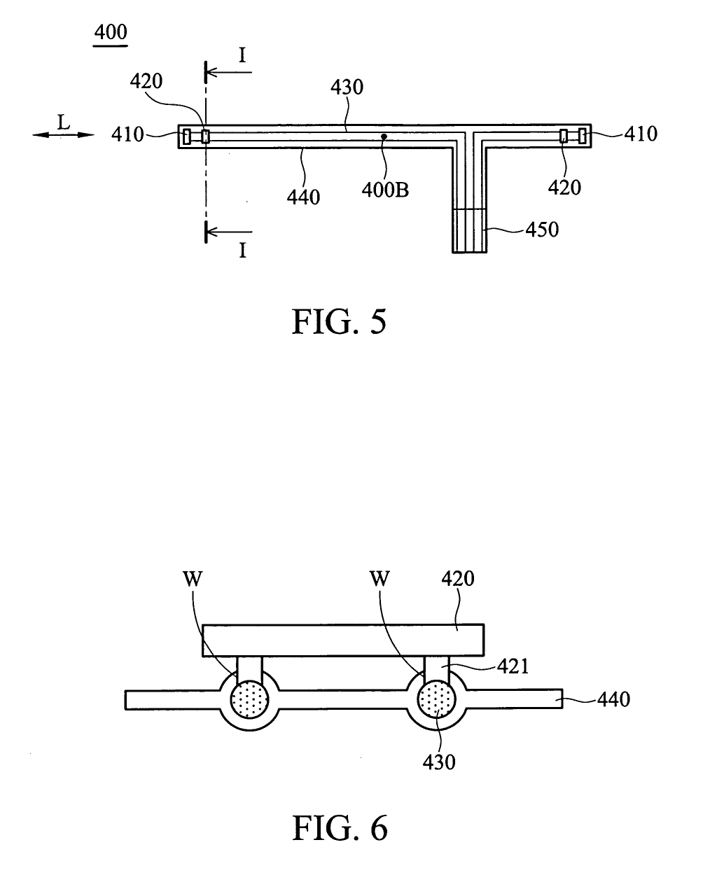

In FIG. 5, the flexible circuit board 400 further comprises a plurality of lead wires 430 and an insulating substrate 440. The lead wires 430 connect all the LEDs 410 and the Zener diode 420 to the port 450, and the insulating substrate 440 encloses the lead wires 430. In the present embodiment, the LED 410 and the Zener diode 420 are juxtaposed on the lead wires 430, i.e., the LED 410 and the Zener diode 420 are disposed on the lead wires 430 in parallel and arranged on the same side of the insulating substrate 440.

In FIG. 6, two openings W are formed on the insulating substrate 440 and located at the corresponding lead wires 430, respectively. The openings W are through holes for exposing the lead wire 430 enclosed by the insulating substrate 440. Two pins 421 of the Zener diode 420 are connected to the lead wires 430 through the openings W respectively. In the present invention, the pin 421 of the Zener diode 420 is connected to the lead wire 430 by welding.

Based on the preferred structure of the flexible circuit board 400, the size of the flexible circuit board 400 can be reduced, and therefore the size of the liquid crystal module F can also be effectively reduced.

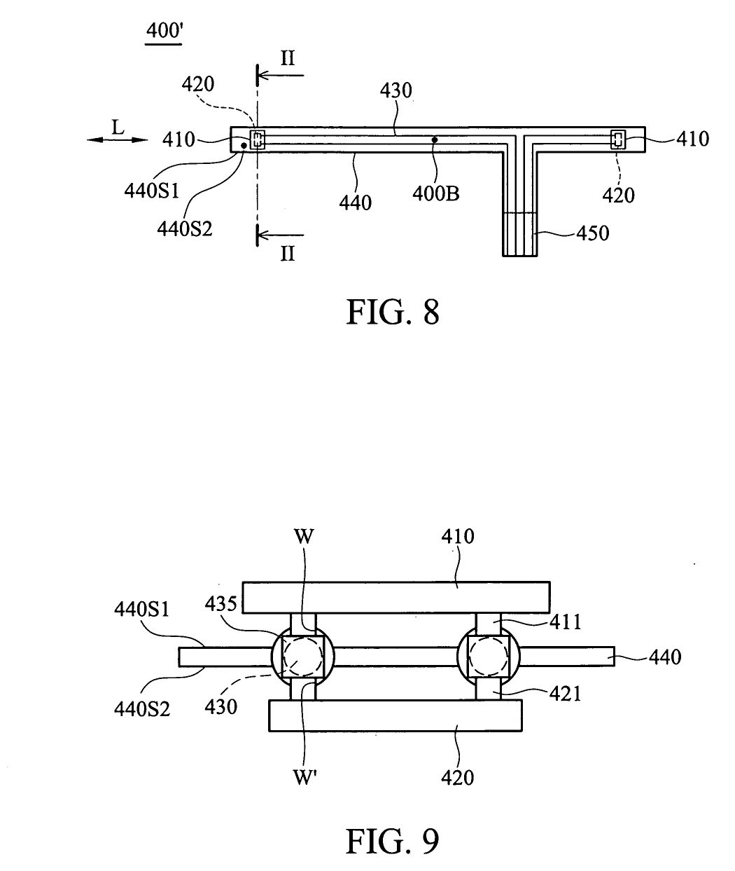

Referring to FIG. 8, in a second embodiment of the invention, a flexible circuit board 400′ is also coupled to the port 450 and disposed on the body 300 mentioned in the first embodiment. The flexible circuit board 400′ differs from the flexible circuit board 400 in that the LED 410 and the Zener diode 420 correspond to each other located on different sides (440S1, 440S2) of the insulating substrate 440.

In FIG. 9, the insulating substrate 440 has a first side 440S1, a second side 440S2, and a plurality of openings W and W′. The openings W are formed on the first side 440S1 and the openings W′ on the second side 440S2. With the openings W, W′, the lead wires 430 enclosed by the insulating substrate 440 is exposed, so that the pins 411 of the LED 410 can be connected to the lead wires 430, 430 through the openings W respectively, and the pins 421 of the Zener diode 420 can be connected to the lead wires 430, 430 through the openings W′ respectively. That is to say, the LED 410 and the Zener diode 420 are disposed on the lead wires 430 in parallel but arranged on different sides (440S1, 440S2) of the insulated substrate 440. A welded point 435 is formed on the intersection of the pin 411 of the LED 410, the lead wire 430 and the pin 421 of the Zener diode 420, so that the LED 410 and the Zener diode 420 can be firmly coupled to the lead wire 430.

The size of the flexible circuit board 400′ is reduced, and thus the size of the liquid crystal module F can also be reduced.

While this invention has been described in connection with what is presently considered to be the most practical and preferred embodiment, it is to be understood that the invention is not limited to the disclosed embodiments, but, on the contrary, is intended to enclose various modifications and equivalent arrangements included within the spirit and scope of the appended claims.

What is claimed is:

1. A liquid crystal module, comprising:
a body; and
a circuit board disposed on the body, having a plurality of lead wires, a plurality of openings exposing the lead wires, an LED coupled to the lead wires, and a Zener diode coupled to the lead wires through the openings, wherein the LED and the Zener diode are juxtaposed on the lead wires.

2. The liquid crystal module as claimed in claim 1, wherein the Zener diode is coupled to the lead wires by welding.

3. The liquid crystal module as claimed in claim 1, wherein the body is rectangular.

4. The liquid crystal module as claimed in claim 1, wherein the body is made of plastic.

5. The liquid crystal module as claimed in claim 1, wherein the liquid crystal module is a liquid-crystal display of a mobile phone.

6. The liquid crystal module as claimed in claim 1, wherein the liquid crystal module is a liquid-crystal display of a personal digital assistant.

7. A liquid crystal module, comprising:
a body; and
a circuit board disposed on the body, having a first side and a second side, a plurality of lead wires located between the first side and the second side, a plurality of openings formed on the first side and the second side to expose the lead wires, an LED coupled to the lead wires through the openings on the first side, and a Zener diode coupled to the lead wires through the openings on the second side, wherein the LED and the Zener diode are disposed on the lead wires on the first side and the second side respectively.

8. The liquid crystal module as claimed in claim 7, wherein the Zener diode and the LED are correspondingly located on the first side and the second side.

9. The liquid crystal module as claimed in claim 7, wherein the Zener diode is coupled to the lead wires by welding.

10. The liquid crystal module as claimed in claim 7, wherein the body is rectangular.

11. The liquid crystal module as claimed in claim 7, wherein the body is made of plastic.

12. The liquid crystal module as claimed in claim 7, wherein the liquid crystal module is a liquid-crystal display of a mobile phone.

13. The liquid crystal module as claimed in claim 7, wherein the liquid crystal module is a liquid-crystal display of a personal digital assistant.
